(19) United States
(12) Patent Application Publication
(10) Pub. No.: US 2011/0244351 A1
(43) Pub. Date: Oct. 6, 2011

(54) OPERATING METHOD OF FUEL CELL SYSTEM

(76) Inventors: Jung-Kurn Park, Yongin-si (KR); Young-Seung Na, Yongin-si (KR); Hye-Jung Cho, Yongin-si (KR); Lei Hu, Yongin-si (KR)

(21) Appl. No.: 13/037,217

(22) Filed: Feb. 28, 2011

Related U.S. Application Data
(60) Provisional application No. 61/320,261, filed on Apr. 1, 2010.

(51) Int. Cl. H01M 8/04

(52) U.S. Cl. 429/431

(57) ABSTRACT

A method of operating a fuel cell includes: generating an electrical power in a fuel cell stack while no fuel is being supplied from a fuel tank; reducing an output voltage of the electrical power toward a target voltage to increase an output current of the electrical power; measuring a rate of increase of the output current; starting supply of fuel to the fuel cell stack when the rate of increase of the output current is below a threshold rate; and controlling a fuel concentration in the fuel cell stack to maintain the output current at a target current level.

### CROSS-REFERENCE TO RELATED APPLICATION

This application claims priority to and the benefit of U.S. Provisional Patent Application No. 61/320,261, filed Apr. 1, 2010 in the United States Patent and Trademark Office, the entire content of which is incorporated herein by reference.

### BACKGROUND

1. Field

Aspects of embodiments of the present invention relate to a system and method of operating a fuel cell system.

2. Description of the Related Art

A fuel cell, as a device for electrochemically generating power by using fuel (hydrogen or reformed gas) and oxidant (oxygen or air), directly converts the fuel and the oxidant, which are continuously supplied from the outside (e.g., an external source), into electrical energy by an electrochemical reaction.

For example, the fuel cell may use pure oxygen (or air containing a large amount of oxygen) as the oxidant and pure hydrogen (or fuel containing a large amount of hydrogen generated by reforming hydrocarboneous fuel (LNG, LPG, CH₃OH)) as the fuel.

### SUMMARY

Aspects of the present invention are directed toward a method and/or system of operating a fuel cell stack capable of easily (or stably) supplying fuel to the fuel cell stack without using a concentration sensor.

According to an embodiment of the present invention, a method of operating a fuel cell system includes: generating an electrical power in a fuel cell stack while no fuel is being supplied from a fuel tank; reducing an output voltage of the electrical power toward a target voltage to increase an output current of the electrical power; measuring a rate of increase of the output current; starting supply of fuel to the fuel cell stack when the rate of increase of the output current is below a threshold rate; and controlling a fuel concentration in the fuel cell stack to maintain the output current at a target current level.

The generating of the electrical power may include operating the fuel cell stack until the output voltage of the electrical power generated by the fuel cell stack is stabilized at an open circuit voltage level. In the reducing of the output voltage of the electrical power, the output voltage may decrease until it reaches the target voltage. In one embodiment, the threshold rate is not greater than 0 A/s. The threshold rate may be between 0 A/s and −0.5 A/s. The output voltage may be maintained at the target voltage. The controlling of the fuel concentration in the fuel cell stack may include: supplying the fuel during a first period of time; and stopping the supplying of the fuel during a second period of time.

The controlling of the fuel concentration in the fuel cell stack may include operating a fuel pump to supply the fuel from the fuel tank to a mixer. The controlling of the fuel concentration in the fuel cell stack may further include mixing, in the mixer, the fuel from the fuel tank with water. The fuel pump may be controlled by a controller selected from the group including a proportional controller, a proportional-integral controller, and a proportional-integral-derivative controller.

The method of operating the fuel cell system may further include: maintaining the output voltage at the target voltage; detecting a temperature in the fuel cell stack; and reducing the target voltage when the detected temperature is greater than a threshold temperature. The reducing of the target voltage may include controlling the concentration of fuel in the fuel cell stack to maintain the output voltage at the reduced target voltage. The threshold temperature may be between 2% and 10% greater than a reference operating temperature.

The method of operating the fuel cell system may further include: maintaining the output voltage at the target voltage; measuring a power supplied to a fan configured to cool the fuel cell stack; and reducing the target voltage when the measured power supplied to the fan is greater than a threshold power. The threshold power may be 5% to 20% greater than a reference operating power. The reference operating power may be 70% of a maximum use power of the fan.

In another embodiment of the present invention, a system for operating a fuel cell system includes: a fuel cell stack configured to generate an electrical power while no fuel is being supplied from a fuel tank; a peripheral device configured to reduce an output voltage of the electrical power toward a target voltage to increase an output current of the electrical power and to measure a rate of increase of the output current; and a controller configured to start supply of fuel to the fuel cell stack when the rate of increase of the output current is below a threshold rate and to control a fuel concentration in the fuel cell stack to maintain the output current at a target current level.

### BRIEF DESCRIPTION OF THE DRAWINGS

FIG. 1 is a schematic diagram of a fuel cell system according to a first exemplary embodiment of the present invention;

FIG. 2 is a flowchart showing a method of operating a fuel cell system according to the first exemplary embodiment of the present invention;

FIG. 3 is a graph of voltage and current against time according to the method of operating a fuel cell system shown in FIG. 2.

FIG. 4 is a schematic diagram of a fuel cell system according to a second exemplary embodiment of the present invention;

FIG. 5 is a flowchart showing a method of operating a fuel cell system according to the second exemplary embodiment of the present invention;

FIG. 6 is a graph showing the voltage, current, power, and fuel concentration of the stack over time according to the methods of operating the fuel cell system according to the first and second exemplary embodiments of the present invention;

FIG. 7 is a graph showing the current and fuel concentration over time according to the method of operating the fuel cell system according to the first and second exemplary embodiments of the present invention;

FIG. 8 is a graph showing a stack temperature, an anode temperature, and an external temperature over time according to the methods of operating the fuel cell system according to the first and second exemplary embodiments of the present invention;

FIG. 9 is a graph showing the power, voltage, current, and fuel concentration of the stack over time when restarting the operation by the methods of operating the fuel cell system according to the first and second exemplary embodiments of the present invention;

FIG. 10 is a graph showing the current and fuel concentration of the stack over time when restarting the operation by the methods of operating the fuel cell system according to the first and second exemplary embodiments of the present invention;

FIG. 11 is a schematic diagram of the fuel cell system according to a third exemplary embodiment of the present invention; and

FIG. 12 is a flowchart showing a method of operating the fuel cell system according to the third exemplary embodiment of the present invention.

### DETAILED DESCRIPTION

Aspects of embodiments of the present invention will be described more fully hereinafter with reference to the accompanying drawings. As those skilled in the art would realize, the described embodiments may be modified in various different ways, all without departing from the spirit or scope of the present invention.

It is important to supply a uniform amount of fuel to the fuel cell system. In a 20 W direct methanol fuel cell system, if a flux (or flow of fuel through the fuel cell stack) changes by 0.03 cc/min, then the fuel efficiency of the fuel cell system may change by about 10%. The change in the flux changes operating states (or conditions) such as operating concentration, operating temperature, operating pressure, etc., which reduces the stability of the fuel cell stack and reduces the life-span of the fuel cell.

A commonly adopted method for finely (or precisely) controlling a flux (or flow of fuel) uses a precision concentration sensor and a high precision pump.

However, the precision concentration sensor cannot precisely measure the concentration when the temperature changes. A method of correcting the concentration sensor according to the change in temperature has been used. However, it is difficult for this method to precisely correct the measured concentration according to the change in ambient temperature because a temperature sensor is also affected by heat generated by the fuel cell stack.

In addition, when the fuel cell system is used (or operated) for a long time, the zero point (or zeroing point) of the precision concentration sensor changes, thereby giving rise to error in the measured concentration.

Further, a low flux and high precision pump is vulnerable to foreign matter introduced therein and has severely deteriorated performance and weak durability when it is operated for a long time. Since the low flux and high precision pump is generally manufactured (or designed) to be used in a laboratory, its durability is weakened (or reduced) when it is used in a place where fuel with a large amount of foreign matter is supplied for a long time.

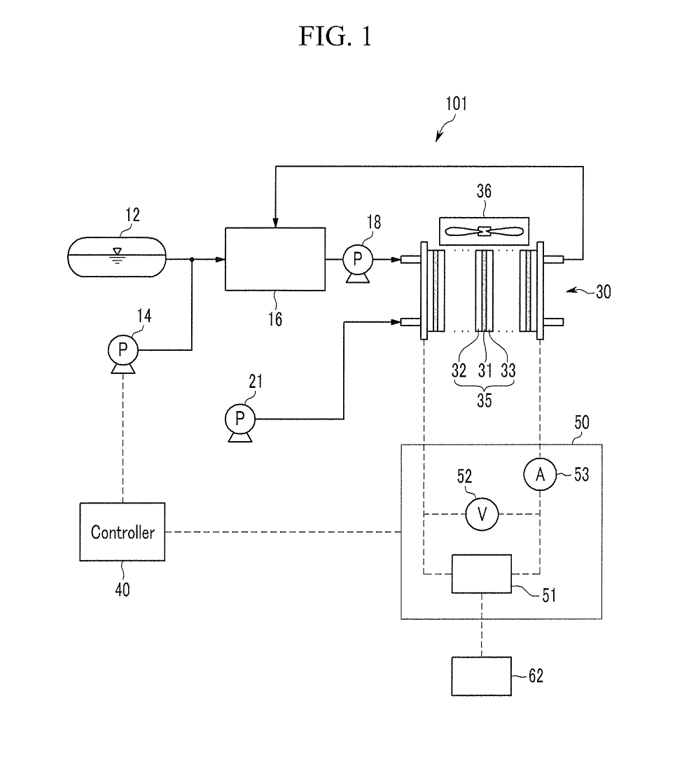

FIG. 1 is a schematic diagram of a fuel cell system according to a first exemplary embodiment of the present invention.

Referring to FIG. 1, a fuel cell system 101 according to the first exemplary embodiment may use a direct methanol fuel cell system that generates electrical energy through the direct reaction of methanol and oxygen.

However, embodiments of the present invention are not limited thereto. The fuel cell system according to the first exemplary embodiment may be configured as a direct oxidation fuel cell that reacts liquid and gas fuel containing hydrogen such as ethanol, LPG, LNG, gasoline, butane gas, etc. with oxygen. In addition, the fuel cell system may be configured as a polymer electrode membrane fuel cell (PEMFC) that reforms fuel into hydrogen-rich reformed gas and oxidizes the hydrogen-rich reformed gas to generate electricity.

The fuel used in the fuel cell system 101 may be a hydrocarboneous fuel composed of a liquid or gas such as methanol, ethanol, natural gas, LPG, etc.

However, the fuel cell system 101 may use air or oxygen gas that is stored in a separate storage unit as an oxidant reacting with hydrogen in the fuel.

The fuel cell system 101 according to the first exemplary embodiment includes a fuel cell stack 30 that generates power using fuel and oxidant, a fuel tank 12 that supplies fuel to the fuel cell stack 30, an oxidant pump 21 that supplies oxidant to the fuel cell stack 30 to generate electricity, and a mixer 16 that is installed between the fuel cell stack 30 and the fuel tank 12.

The first fuel pump 14 is connected to the fuel tank 12 to discharge the liquid fuel stored in the fuel tank 12 from the fuel tank 12 by a pumping force (e.g., a predetermined pumping force). In the first exemplary embodiment, the fuel stored in the fuel tank 12 may be composed of (or include) methanol. Also, the oxidant pump 21 serves to supply air to the fuel cell stack 30.

The mixer 16 mixes the fuel supplied from the fuel tank 12 and water drawn from the fuel cell through a withdraw pipe and supplies the mixture to the fuel cell stack 30. A second fuel pump 18, which supplies the fuel stored in the mixer 16 to the fuel cell stack 30, is installed between the mixer 16 and the fuel cell stack 30.

The fuel cell stack 30 includes a plurality of electric generators 35 that induce the oxidation/reduction reaction of fuel and oxidant to generate electrical energy.

Each electric generator 35 includes a unit cell that generates electricity and includes a membrane-electrode assembly 31 (MEA) that oxidizes fuel and reduces oxygen in the oxidant and includes separators 32 and 33 (also known in the field as bipolar plates) that supply fuel and oxidant to the membrane electrode assembly 31.

The electric generator 35 has a structure in which each of the separators 32 and 33 is disposed at opposing sides of the membrane-electrode assembly 31. The separators 32 and 33 are closely attached to each other, with the membrane-electrode assembly 31 located between the separators 32 and 33, thereby forming a fuel passage and an air passage at opposite sides of the membrane-electrode assembly 31. The fuel passage is disposed at an anode side of the membrane-electrode assembly 31, and the air passage is disposed at a cathode side of the membrane-electrode assembly 31. The electrolyte membrane moves protons generated from the anode to the cathode to react with oxygen of the cathode electrode, thereby achieving ion exchange and water generation.

As a result, hydrogen is decomposed into electrons and protons (hydrogen ions) in the anode by the oxidation reaction. The protons move to the cathode electrode through the electrolyte membrane, and the electrons move to the cathode of the adjacent membrane-electrode assembly 31 through the separator 33 (and not through the electrolyte membrane). Current is generated by the flow of electrons. In addition, moisture is generated in the cathode by the reduction reaction of the moved protons, the moved electrons, and oxygen.

The fuel cell system 101 includes the fuel cell stack 30 which includes a plurality of electric generators 35. One side of the fuel cell stack 30 is provided with a cooling fan 36 for cooling the fuel cell stack 30. Since a large amount of heat is generated in the fuel cell stack during electricity generation, the cooling fan 36 supplies air to the fuel cell stack 30 to lower the temperature of (or cool) the fuel cell stack 30.

The fuel cell stack 30 according to the first exemplary embodiment is a 30 W fuel cell stack 30 that has a small capacity. However, this is only an example description and therefore, embodiments of the present invention are not limited thereto.

A peripheral device 50 electrically connects the fuel cell stack 30 to a load 62. The peripheral device 50 includes a voltage sensor 52, a current sensor 53, and converter 51. The voltage sensor 52 measures the voltage (or output voltage) of the fuel cell stack 30, and the current sensor 53 measures the current (or output current) of the fuel cell stack. Further, the converter 51 serves to correct the output voltage and output current so that the voltage and current of power generated from the fuel cell stack 30 can be used in the load. The converter 51 is connected to the load 62 to supply power to the load 62. The fuel cell system 101 also includes a controller 40 for controlling the operation of the first fuel pump 14 in accordance with the measured voltage and current.

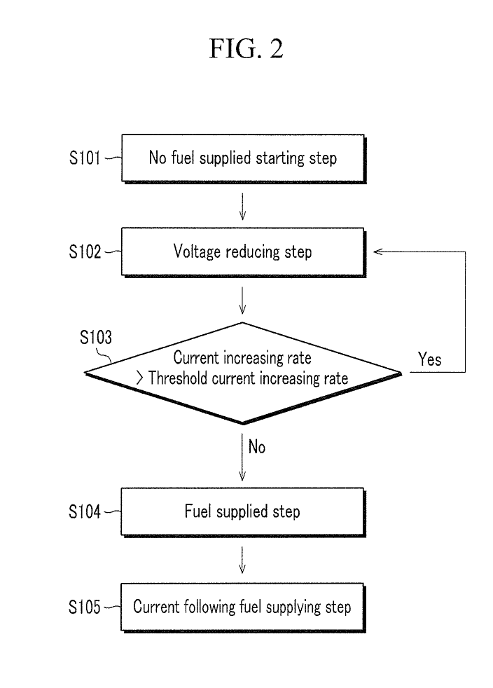

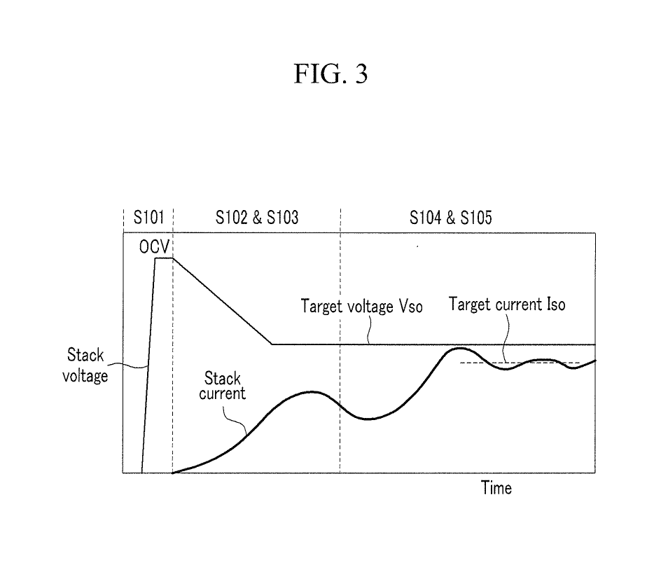

FIG. 2 is a flowchart showing a method of operating a fuel cell system according to the first exemplary embodiment of the present invention, and FIG. 3 is a graph of voltage and current against time in accordance with the method of operating a fuel cell system shown in FIG. 2.

A method of operating a fuel cell system according to the first exemplary embodiment will be described with reference to FIGS. 2 and 3.

The method of operating the fuel cell system 101 according to the first exemplary embodiment includes a starting step in which no fuel is supplied (S101), a voltage reducing step (S102), a current increase rate measuring step (S103), a fuel supplied step (S104), and a current following fuel supplying step (S105).

At the operation starting step in which no fuel is supplied (S101), the fuel cell system 101 starts its operation by connecting the converter 51 to the fuel cell stack 30 in the state where the supply of fuel is stopped. While the supply of fuel is stopped, the fuel cell system 101 is operated at a constant voltage until the open circuit voltage (OCV) is stable. When the open circuit voltage is stable (or stabilizes), the output voltage (stack voltage) decreases (e.g., the converter 51 decreases the output voltage) at a rate (e.g., a constant rate) until it reaches the target voltage (Vₛₒ). As the output voltage decreases, an output current (stack current) increases (to maintain a constant power output) until the current eventually stops increasing and begins to decrease. The output current begins to decrease because the fuel remaining in the fuel cell stack 30 is exhausted for electricity generation. That is, the time when current starts to decrease may be considered as the time when fuel concentration in the fuel cell stack 30 is minimized or substantially minimized.

The current increase rate measuring step (S103) measures the rate at which the current is increasing to determine whether the current increase rate is smaller than a target increase rate (Iᵣₛₒ). The fuel supplied step (S104) starts the supply of fuel to the fuel cell stack 30 when the current increase rate is smaller than the target increase rate (Iᵣₛₒ). In one embodiment, the target increase rate of current (Iᵣₛₒ) is in the range of 0 A/s to −0.5 A/s.

During the current following fuel supplying step (S105), after the supply of fuel starts, the fuel concentration is controlled according to the output of current so that the target current (Iₛₒ) can be output from the fuel cell stack 30. At this time, the output voltage of the fuel cell stack 30 is constantly fixed to (or fixed at) the target voltage (Vₛₒ) by the converter. The target voltage (Vₛₒ) and the target current (Iₛₒ) can be suitably set according to the type of fuel cell system. For example, in the case of the fuel cell system having a rated output of 60 W, the target voltage may be 1.5V and the target current may be 40 A. As another example, in the case of a fuel cell system having a rated output of 300 W, the target voltage may be 6V and the target current may be 50 A.

The current following fuel supplying step (S105) includes repeatedly supplying and stopping the supply of fuel to the mixer 16. In the first exemplary embodiment, a first fuel pump 14, which may be a low precision pump, is used and the supplying of fuel and the stopping the supply of fuel are performed during a period (e.g., a predetermined period in which the supplying of fuel is performed during a first period and stopping the supply of fuel is performed during a second period), which can obtain the same effect as supplying a uniform (or constant) amount of fuel for the entire period. For example, when it is desired to supply 1/10 of the maximum amount of fuel that can be supplied by the first fuel pump 14, the first fuel pump supplies fuel for 1/10 of the period (e.g., where the first period is 1/10 time units long) and stops the supply of fuel for 9/10 of the period (e.g., where the second period is 9/10 time units long), thereby making it possible to obtain the desired precision (e.g., to supply the desired amount of fuel). The fuel introduced into the mixer 16 is sufficiently mixed with water and then introduced into the fuel cell, thereby making it possible to secure a uniform (or stable) concentration.

As described above, the output voltage is fixed to the target voltage (Vₛₒ) and the output current changes according to the fuel concentration, thereby making it possible to minimize or reduce the damage to the fuel cell stack 30. In contrast, if the target current (Iₛₒ) is forcibly output by the converter, the reaction is forcibly generated, such that the fuel cell stack 30 may be damaged.

Since the fuel concentration is determined according to the amount of fuel supplied from the fuel tank 12, the controller 40 controls the operation of the first fuel pump 14 in accordance with the measured current, such that the first fuel pump 14 can be controlled by various suitable methods such as proportional (P), proportional-integral (PI), proportional-integral-derivative (PID) control, etc. are widely known in the art and therefore, detailed description thereof will be omitted.

According to the first exemplary embodiment, the controller 40 controls the amount of fuel supplied in accordance with the output current to maintain the output current substantially at the target current Iₛₒ without using a concentration sensor and thus, fuel can be supplied more easily. In addition, the high-concentration fuel and water are mixed in the mixer 16 and then supplied to the fuel cell stack 30, such that a low precision pump can be used. When an amount of fuel (e.g., a predetermined amount of fuel) is supplied from the fuel tank 12 to the mixer 16 periodically using the low precision pump by the controller 40 (e.g., a PID controller, etc.), a stable concentration of fuel (e.g., a predetermined concentration of fuel) can be continuously (or stably) supplied.

At the time of starting operation of the fuel cell stack 30, the temperature of the fuel cell stack 30 is low, and the electricity is not actively being generated. If the fuel cell stack 30 was initially controlled to output the target current by controlling the fuel concentration, then high-concentration fuel would be supplied (or initially supplied) to the fuel cell stack 30, such that the fuel cell stack 30 may be damaged. However, according to the first exemplary embodiment, the operation of the fuel cell stack 30 starts without supplying fuel from the fuel tank 12, and fuel is supplied (or begins to be supplied) in the state where the fuel concentration in the fuel cell stack 30 is substantially minimized, such that the high-concentration fuel is not supplied although fuel (e.g., lower concentration fuel) is supplied to output the target current. In addition, the operation starts by using the fuel remaining in the fuel cell stack 30, and fuel is supplied (or begins to be supplied) in the state where the temperature of the fuel cell stack 30 is increased, thereby making it possible to smoothly output the target current.

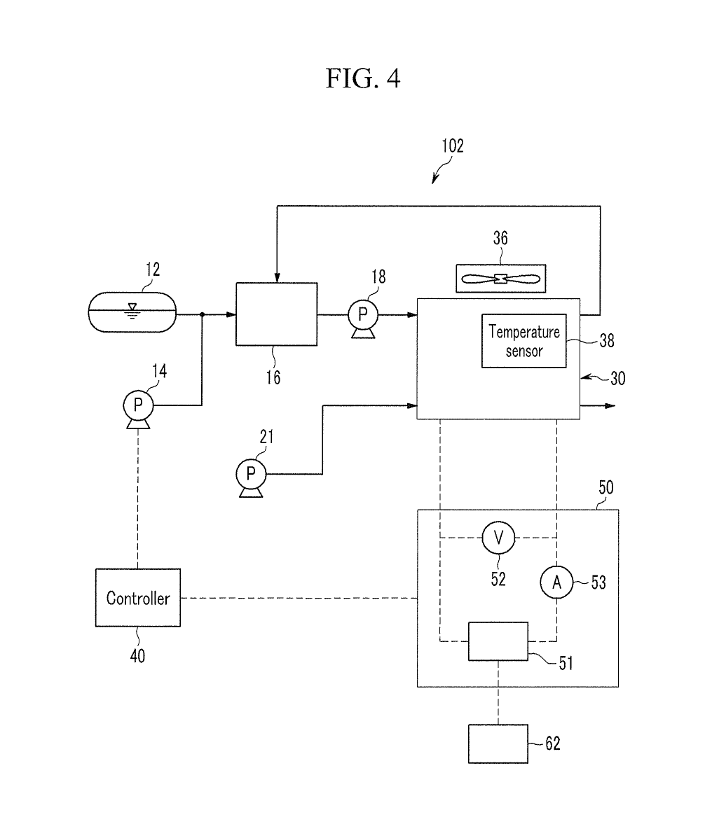

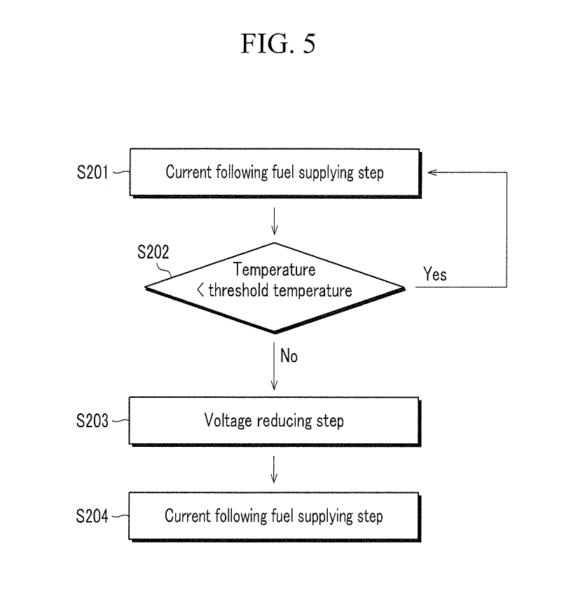

FIG. 4 is a schematic diagram of a fuel cell system according to a second exemplary embodiment of the present invention and FIG. 5 is a flowchart showing a method of operating the fuel cell system according to the second exemplary embodiment of the present invention.

Referring to FIGS. 4 and 5, a fuel cell system 102 according to the second exemplary embodiment further includes a temperature sensor 38 that is installed in the fuel cell stack 30. The fuel cell system 102 has the same configuration as the fuel cell system according to the first exemplary embodiment, except for the temperature sensor 38 and therefore, the detailed description of similar components will be omitted.

A method of operating the fuel cell system 102 according to the second exemplary embodiment includes a current following fuel supplying step (S201) under a first target voltage, a fuel cell stack temperature measuring step (S202), a voltage reducing step (S203), and a current following fuel supplying step (S204) under a second target voltage.

The current following fuel supplying step (S201) under the first target voltage controls the concentration of fuel supplied to the fuel cell stack 30, thereby making it possible to output the target current (Iₛₒ). At this time, the constant voltage (CV) operation that maintains the output voltage at the first target voltage (Vₛₒ₁) is performed.

The fuel cell stack temperature measuring step (S202) measures the temperature of the fuel cell stack 30 to determine whether the temperature of the fuel cell stack 30 is higher than a threshold temperature (Tₛₗ). When the fuel cell system 102 is operated for a long time, the performance of the fuel cell stack 30 deteriorates and thus, the target current may not be outputted at the first target voltage (Vₛₒ₁) condition. In this case, in order to output the target current (Iₛₒ), there is the problem in that high-concentration fuel (or additional fuel) is supplied to the fuel cell stack 30. When the high-concentration fuel is supplied, excessive heat may be generated in the fuel cell stack 30 which may damage the fuel cell stack 30. In the second exemplary embodiment, in order to cool the fuel cell stack 30, a cooling fan 36 is disposed at one side of the fuel cell stack 30, and the cooling fan 36 is set to rotate at a constant speed. Therefore, the fuel cell stack temperature measuring step (S202) can use the temperature sensor 38 to determine whether the temperature of the fuel cell stack 30 is higher than a threshold temperature (Tₛₗ).

The threshold temperature (Tₛₗ) is set to a temperature 2% to 10% higher than a reference operating temperature. Since the reference operating temperature depends on the type of the fuel cell system, the threshold temperature (Tₛₗ) can be suitably set according to the reference operating temperature. For example, a direct methanol fuel cell (DMFC), which has reference operating temperature of 62° C., may have its threshold temperature (Tₛₗ) set to, for example, a temperature in the range of 63.4° C. to 682° C.

The voltage reducing step (S203) reduces the target voltage from the first target voltage (Vₛₒ₁) to the second target voltage (Vₛₒ₂) when the temperature of the fuel cell stack 30 is higher than the threshold temperature (Tₛₗ). When reducing the target voltage according to the performance degradation of the fuel cell stack 30, the target current is output (or continues to be output), and the fuel concentration is not excessively high (or does not rise to an excessively high level).

The current following fuel supplying step (S204) under the second target voltage (Vₛₒ₂) controls the fuel pump 14 to output the target current (Iₛₒ) while substantially fixing (or maintaining) the output voltage at the second target voltage (Vₛₒ₂).

As described above, according to the second exemplary embodiment, even when the performance of the fuel cell stack 30 deteriorates during a long-time operation (or after it has been operated for a long time), it can stably supply fuel while preventing the fuel concentration from increasing excessively without using a concentration sensor.

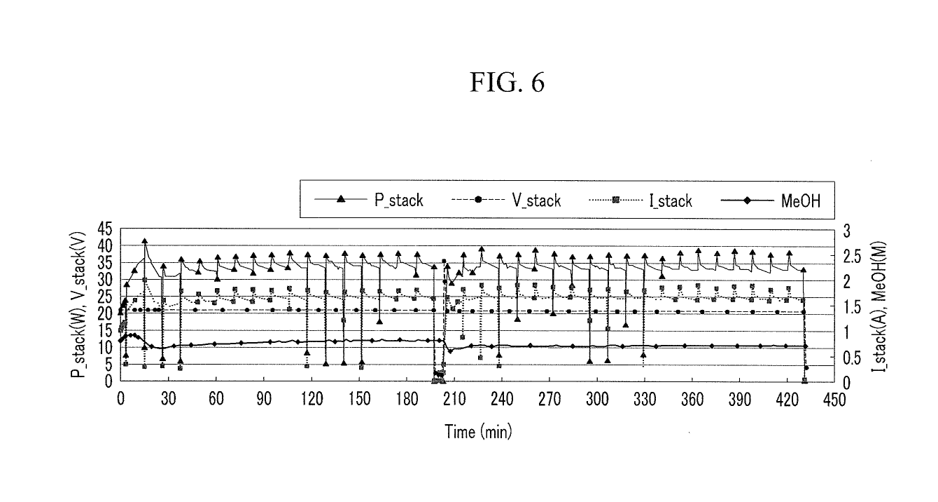

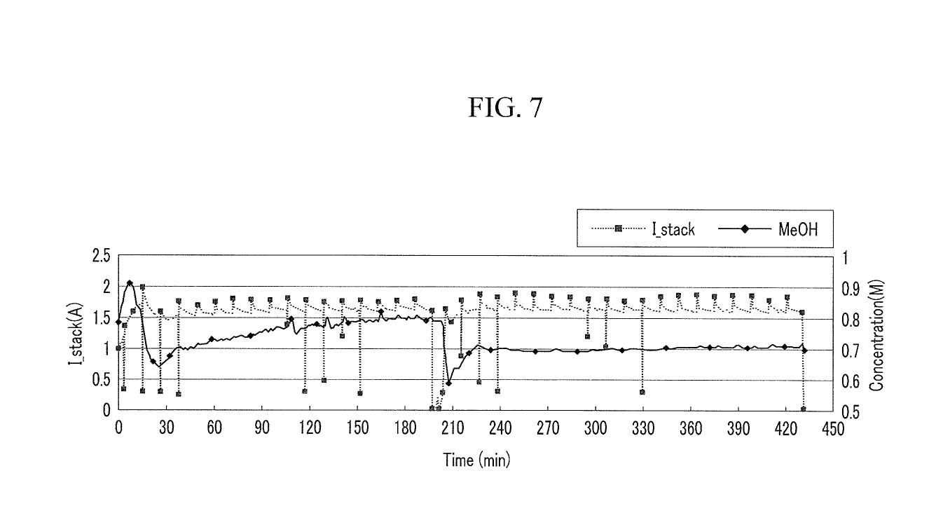

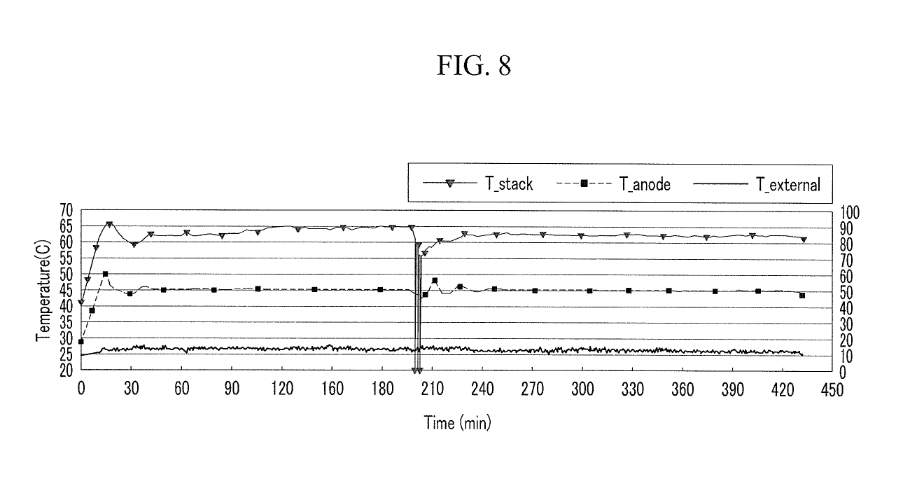

FIG. 6 is a graph showing the voltage (V_stack), current (I_stack), power (P_stack), and fuel concentration (MeOH) of the fuel cell stack over time according to methods of operating the fuel cell system according to the first and second exemplary embodiments of the present invention, FIG. 7 is a graph showing the current (I_stack) and fuel concentration (MeOH) over time according to the method of operating the fuel cell system according to the first and second exemplary embodiments of the present invention, and FIG. 8 is a graph showing a stack temperature (T_stack), an anode temperature (T_anode), and an external temperature (T_external) over time according to the method of operating the fuel cell system according to the first and second exemplary embodiments of the present invention.

Referring to FIGS. 6 to 8, the exemplary fuel cell stack having its operating characteristics shown in the graphs is a fuel cell that has a rated output of 30 W, a rated voltage of 20V, and a rated current of 1.5 A.

First, as shown in FIG. 7, when the fuel cell system starts, it is operated in the same manner as the first exemplary embodiment such that the concentration ranges between 0.63 M to 0.9 M. In addition, after the fuel cell system starts, it is confirmed that the fuel concentration is stabilized to be in the range 0.68M to 0.72 M after between 240 minutes and 430 minutes.

As shown in FIG. 6 to FIG. 8, beginning at the time when the operation of the fuel cell system starts to about 200 minutes after start, the fuel concentration increases and the temperature of the fuel cell stack increases to about 65° C. When the target voltage of the fuel cell stack 30 is lowered from 22 V to 21 V at about 200 minutes, the fuel concentration is reduced for a while and then is stably maintained (or maintained at a stable level) beginning at about 230 minutes after start. At this time, the temperature, fuel concentration, current, and voltage of the fuel cell stack 30 are stably maintained.

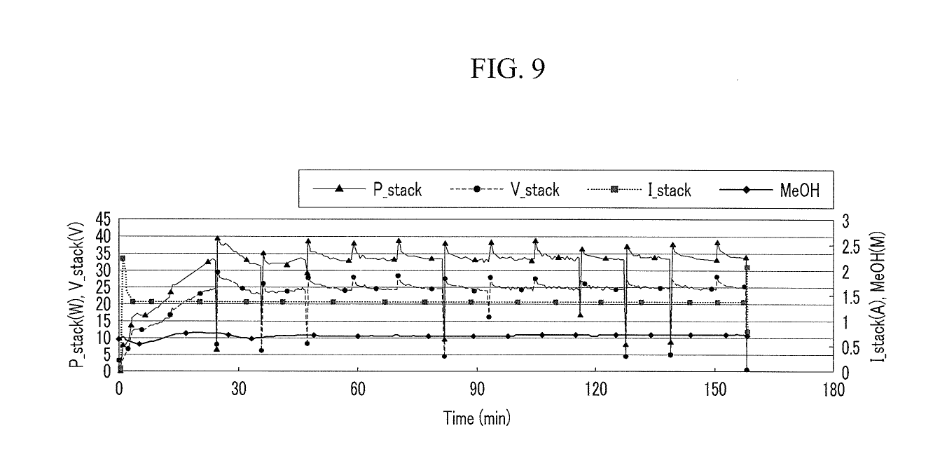

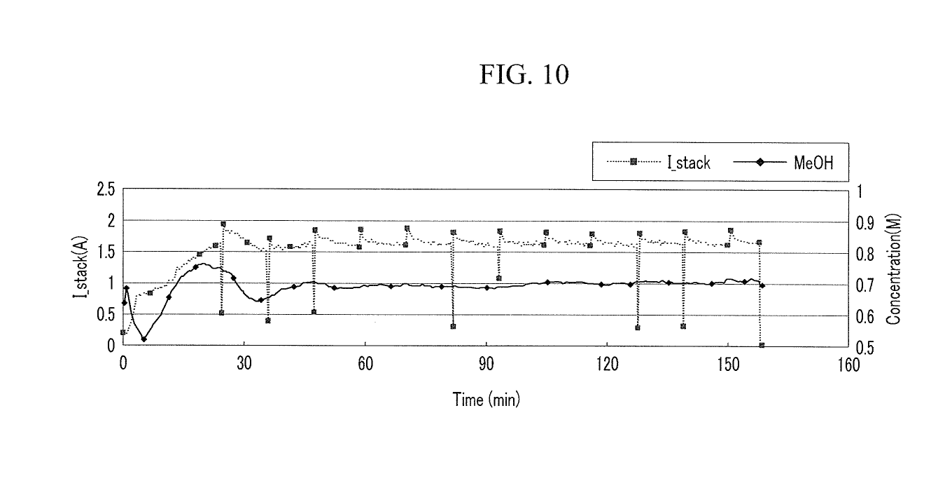

FIG. 9 is a graph showing the power (P_stack), voltage (V_stack), current (I_stack), and fuel (MeOH) concentration of the stack when restarting the operation of the fuel cell system by the methods of operation according to the first and second exemplary embodiments of the present invention and FIG. 10 is a graph showing the current (I_stack) and fuel concentration (MeOH) of the stack when restarting the operation of the fuel cell system by the methods of operation according to the first and second exemplary embodiments of the present invention.

FIGS. 9 and 10 show the operation of the exemplary fuel cell system when the fuel cell system restarts in a state in which the target voltage of the fuel cell system is lowered. As shown in FIGS. 8 and 9, 30 minutes after the fuel cell system starts, the supplied fuel concentration is in a stable state and the current and power are stably output.

As described above, according to the first and second exemplary embodiments, when the fuel cell system starts and while the fuel cell system is operated, it can supply fuel with stable concentration in accordance with the target current without using a concentration sensor.

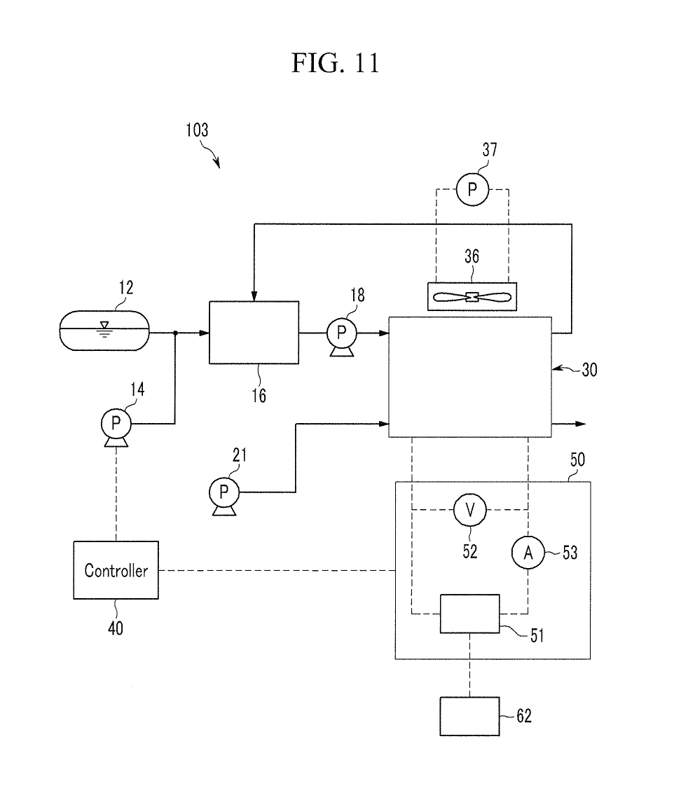

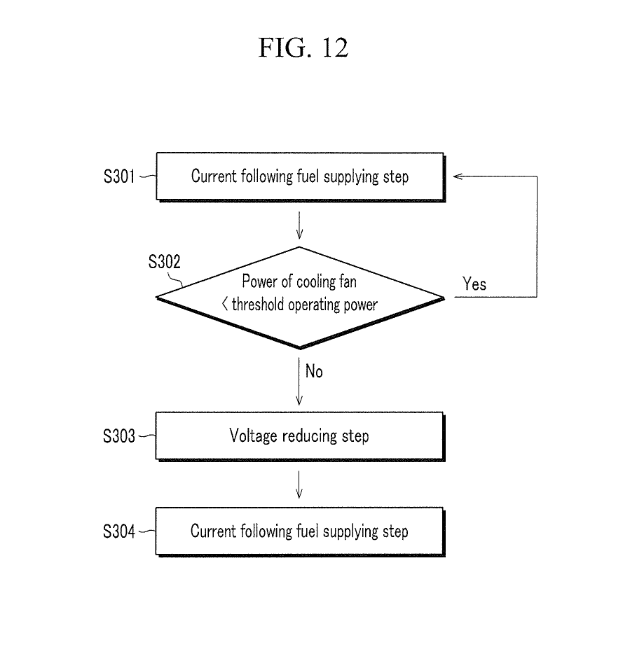

FIG. 11 is a schematic diagram of a fuel cell system according to a third exemplary embodiment of the present invention and FIG. 12 is a flowchart showing a method of operating the fuel cell system according to the third exemplary embodiment of the present invention.

Referring to FIGS. 11 and 12, a fuel cell system 103 according to the third exemplary embodiment further includes a power sensor 37 that measures an operating voltage of the cooling fan 36. The fuel cell system has substantially the same configuration as the fuel cell system according to the first exemplary embodiment, except for the power sensor 37 and therefore, the description of similar components will be omitted.

A method of operating the fuel cell system 103 according to the third exemplary embodiment includes a current following fuel supplying step (S301) under a first target voltage (Vₛₒ₁), a step of measuring operating power (P_{f}) of a cooling fan 36 (S302), a voltage reducing step (S303), and a current following fuel supplying step (S304) under a second target voltage (Vₛₒ₂).

The current following fuel supplying step (S301) under the first target voltage (Vₛₒ₁) controls the fuel concentration to be supplied to the fuel cell stack 30, in order to output the target current (Iₛₒ). At this time, the output voltage is substantially maintained at the first target voltage (Vₛₒ₁).

Also, the step (S302) of measuring the operating power (P_{f}) of the cooling fan 36 uses the power sensor 37 to measure the operating power (P_{f}) of the cooling fan 36 and determines whether the operating power (P_{f}) of the cooling fan 36 is higher than a threshold power (P_{fl}).

When the fuel cell system 103 is operated for a long time, the performance of the fuel cell stack 30 deteriorates and thus the target current is not outputted at the first target voltage (Vₛₒ₁) condition. In this case, in order to output the target current (Iₛₒ) at the first target voltage (Vₛₒ₁), the high-concentration fuel would need to be supplied to the fuel cell stack 30. However, when the high-concentration fuel is supplied, excessive heat may be generated in the fuel cell stack 30 and the fuel cell stack 30 may be damaged.

In the third exemplary embodiment, when the temperature in the fuel cell stack 30 increases, the rotation speed of the cooling fan 36 increases so that the fuel cell stack 30 can maintain a substantially stable temperature (e.g., a predetermined temperature). Therefore, when excessive heat is generated in the fuel cell stack 30, the operating power (P_{f}) of the cooling fan 36 is increased to increase the rotation speed of the cooling fan 36, and the operating power (P_{f}) of the cooling fan 36 is measured to determine whether the operating power (P_{f}) of the cooling fan 36 is higher than the threshold operating power (P_{fl}).

Herein, the threshold operating power (P_{fl}) is set to power 5% to 20% higher than a reference operating power. Since the reference operating power depends on the size of the fuel cell system, the threshold operating power (P_{fl}) can be set according to the reference operating voltage. For example, when the reference operating power is 70% of the maximum use power, the threshold driving power (P_{fl}) may be in the range of 73.5% to 84% of the maximum use power.

The voltage reducing step (S303) reduces the target voltage from the first target voltage (Vₛₒ₁) to the second target voltage (Vₛₒ₂) when the operating power (P_{f}) of the cooling fan 36 is higher than the threshold driving power (P_{fl}). When reducing the target voltage according to the performance degradation of the fuel cell stack 30, the target current is output (or continues to be output), and the fuel concentration is not excessively high (or does not rise to an excessively high level).

The current following fuel supplying step (S304) under the second target voltage (Vₛₒ₂) controls the fuel pump to output the target current (Iₛₒ) while fixing or substantially maintaining the output voltage at the second target voltage (Vₛₒ₂).

As described above, according to the third exemplary embodiment, even though the performance of the fuel cell stack 30 may be degraded due to the long-time operation (or after it has been operated for a long time), it can stably supply fuel while preventing the fuel concentration from excessively increasing.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

Description of Symbols

| | |
|---|---|
| 101, 102, 103: Fuel cell system | 12: Fuel tank |
| 14: First fuel pump | 16: Mixer |
| 18: Second fuel pump | 21: Oxidant pump |
| 30: Fuel cell stack | 36: Cooling fan |
| 31: Membrane-electrode assembly | 32, 33: Separator |
| 35: Electric generator | |
| 37: Power sensor | 38: Temperature sensor |
| 40: Controller | 50: Peripheral device |
| 51: Converter | 52: Voltage sensor |
| 53: Current sensor | 62: Load |

What is claimed is:

1. A method of operating a fuel cell system, the method comprising:
generating an electrical power in a fuel cell stack while no fuel is being supplied from a fuel tank;
reducing an output voltage of the electrical power toward a target voltage to increase an output current of the electrical power;
measuring a rate of increase of the output current;
starting supply of fuel to the fuel cell stack when the rate of increase of the output current is below a threshold rate; and
controlling a fuel concentration in the fuel cell stack to maintain the output current at a target current level.

2. The method of claim 1, wherein the generating of the electrical power comprises operating the fuel cell stack until the output voltage of the electrical power generated by the fuel cell stack is stabilized at an open circuit voltage level.

3. The method of claim 1, wherein in the reducing of the output voltage of the electrical power, the output voltage decreases until it reaches the target voltage.

4. The method of claim 1, wherein the threshold rate is not greater than 0 A/s.

5. The method of claim 4, wherein the threshold rate is between 0 A/s and −0.5 A/s.

6. The method of claim 1, wherein the output voltage is maintained at the target voltage.

7. The method of claim 1, wherein the controlling of the fuel concentration in the fuel cell stack comprises:
supplying the fuel during a first period of time; and
stopping the supplying of the fuel during a second period of time.

8. The method of claim 1, wherein the controlling of the fuel concentration in the fuel cell stack comprises operating a fuel pump to supply the fuel from the fuel tank to a mixer.

9. The method of claim 8, wherein the controlling of the fuel concentration in the fuel cell stack further comprises mixing, in the mixer, the fuel from the fuel tank with water.

10. The method of claim 8, wherein the fuel pump is controlled by a controller selected from the group consisting of a proportional controller, a proportional-integral controller, and a proportional-integral-derivative controller.

11. The method of claim 1 further comprising:
maintaining the output voltage at the target voltage;
detecting a temperature in the fuel cell stack; and
reducing the target voltage when the detected temperature is greater than a threshold temperature.

12. The method of claim 11, wherein the reducing of the target voltage comprises controlling the concentration of fuel in the fuel cell stack to maintain the output voltage at the reduced target voltage.

13. The method of claim 11, wherein the threshold temperature is between 2% and 10% greater than a reference operating temperature.

14. The method of claim 1 further comprising:
maintaining the output voltage at the target voltage;
measuring a power supplied to a fan configured to cool the fuel cell stack; and
reducing the target voltage when the measured power supplied to the fan is greater than a threshold power.

15. The method of claim 14, wherein the threshold power is 5% to 20% greater than a reference operating power.

16. The method of claim 15, wherein the reference operating power is 70% of a maximum use power of the fan.

17. A system for operating a fuel cell system, the system comprising:
means for generating an electrical power in a fuel cell stack while no fuel is being supplied from a fuel tank;
means for reducing an output voltage of the electrical power toward a target voltage to increase an output current of the electrical power;
means for measuring a rate of increase of the output current;
means for starting supply of fuel to the fuel cell stack when the rate of increase of the output current is below a threshold rate; and
means for controlling a fuel concentration in the fuel cell stack to maintain the output current at a target current level.

18. The system of claim 17, wherein the means for controlling the fuel concentration in the fuel cell stack comprises:
means for supplying the fuel during a first period of time; and
means for stopping the supplying of the fuel during a second period of time.

19. The system of claim 17, wherein the means for controlling the fuel concentration in the fuel cell stack comprises:
means for maintaining the output voltage at the target voltage;
means for detecting a temperature in the fuel cell stack; and
means for reducing the target voltage when the detected temperature is greater than a threshold temperature.

20. A system for operating a fuel cell system, the system comprising:
a fuel cell stack configured to generate an electrical power while no fuel is being supplied from a fuel tank;
a peripheral device configured to reduce an output voltage of the electrical power toward a target voltage to increase an output current of the electrical power and to measure a rate of increase of the output current; and
a controller configured to start supply of fuel to the fuel cell stack when the rate of increase of the output current is below a threshold rate and to control a fuel concentration in the fuel cell stack to maintain the output current at a target current level.
